(19) United States
(12) Patent Application Publication
(10) Pub. No.: US 2019/0169731 A1
(43) Pub. Date: Jun. 6, 2019

(54) METHOD FOR ENHANCING WEAR RESISTANCE PROPERTIES OF A MECHANICAL COMPONENT

(71) Applicant: AIRBUS OPERATIONS (S.A.S.), Toulouse (FR)

(72) Inventors: Cédric POUPON, COLOMIERS (FR); Jérôme TERRAZZONI, TOULOUSE (FR)

(21) Appl. No.: 16/202,646

(22) Filed: Nov. 28, 2018

(30) Foreign Application Priority Data
Nov. 29, 2017 (FR) 1761355

(51) Int. Cl. C23C 4/18; C23C 4/02; C23C 4/06; C23C 4/134; B32B 15/01

(52) U.S. Cl. CPC C23C 4/18; C23C 4/02; B32B 15/01; C23C 4/134; C23C 4/06

(57) ABSTRACT

A method for improving wear resistance properties of a component includes depositing by thermal spraying, on all or part of the surface of the component, a layer including molybdenum, putting the surface of the component presenting a layer including molybdenum into contact with an aqueous solution at a temperature above room temperature. A component treated according to such a method is also disclosed.

### CROSS-REFERENCE TO RELATED APPLICATION

This application claims priority to French Patent Application FR 1761355 filed Nov. 29, 2017, the entire disclosure of which is incorporated by reference herein.

### TECHNICAL FIELD

The disclosure herein belongs to the field of surface treatments.

More particularly, the disclosure herein aims to supply a method for treating a component in a durable manner to modify its wear resistance properties and notably the properties of resistance to mechanical wear.

The disclosure herein also relates to the mechanical components thus treated.

### BACKGROUND

Numerous fields of technology employ complex mechanisms in which the movements of the components relative to one another pose problems of wear that may affect the reliability and durability of these components.

Thus, in the aeronautical field, the hinge connections that operate at high temperature between the engine and pylon components are provided by an assembly consisting of a ball joint, shaft and rings.

This ball joint system generally comprises a concave component and a spherical component carried by a shaft. The spherical part, which will fit into the concave part, undergoes rotational motion in all directions, so that the surface of the spherical part and the surface of the concave part are in permanent friction against each other.

In the context of the ball joint system and in other similar systems, two types of wear by friction are distinguished. The first of these types, called “fretting wear”, involves friction of very low amplitude, which is generally of the order of some micrometers. It occurs between two surfaces, of identical or different nature, in contact with one another and subjected to oscillatory motion of the microvibration type, of low enough amplitude so that only partial sliding of the contact is generated. The second type of frictional wear corresponds to wear by sliding, where the amplitude of movement may reach several tens of millimeters.

Frictional wear develops starting from fine asperities present on the rubbing surfaces in contact and which tend to weld together. When the load applied locally is high and in the case when the materials of the two rubbing surfaces are of similar compositions, the friction causes surface wear and degradation, which may even result in seizing of the shaft or ball joint. Moreover, when the environment of the hinge connections has a high temperature, notably between 300° C. and 650° C., this promotes the appearance of adhesive wear, which is ultimately responsible for cases of seizure.

Various methods for improving the wear resistance of rubbing surfaces are already known in the prior art.

For example, there are surface treatments for improving the durability of the rubbing surfaces of titanium alloy and for reducing the wear index. This treatment may consist of depositing a coating layer of titanium nitrides, or else thermochemical treatment based on diffusion of nitrogen, thus allowing the formation of a mixed compound of the TiN and Ti₂N type a few micrometers thick on the surface of the titanium alloy components. However, these treatments are limited to titanium alloy surfaces and are not very suitable for a system of the ball joint type. Moreover, they do not give a significant reduction of wear by sliding and of the phenomenon of seizure.

Patent application FR 3042563 filed in the name of Airbus Operations and published on 21 Apr. 2017 proposes a friction-adapting interface between two components made of nickel, nickel alloy or cobalt-chromium alloy. This interface involves two adapting layers, each deposited on one of the two components. The first of these adapting layers is a microporous layer of an alloy of cobalt, chromium, molybdenum and silicon, whereas the second adapting layer obtained by thermochemical treatment of carbon diffusion on the surface of the second component interacts with the first adapting layer so as to form a layer of oxide on the latter. Although this adapting interface makes it possible to reduce adhesive wear by friction significantly for operating temperatures between 300° C. and 650° C., it is only suitable for components made of nickel, nickel alloy or cobalt-chromium alloy and requires the application of two separate treatments for each of the two components in contact.

We may also mention the use of organic resins for improving wear resistance, which are typically applied in liquid form before being cured and are therefore in the form of lubricating films which must display certain characteristics notably at the level of the coefficient of friction. They must be of small thickness, stable and strong. In fact, in all the fields concerned and notably in the aeronautical field, the organic resin film used for reducing wear between moving parts must be of very small thickness so as not to disturb the operating principle of the devices. The presence of the organic resin film must not lead to contamination of the mechanisms or of the environment, for example owing to excessive vapor pressure, phenomena of outgassing or flows of liquid. Moreover, the organic resin must have high stability to ensure that the friction performance is maintained and to limit the development of phenomena of pollution through formation of degradation byproducts, for a time compatible with the periods during which it is impossible to service the moving parts. The organic resin must also have very high resistance with respect to aggressive environments.

The disclosure herein has an aim of proposing a method that is easy to implement and makes it possible to improve the wear resistance properties of any system in which the movement of two components relative to one another poses problems of wear, regardless of the material or materials of the two components and regardless of the operating temperature.

### SUMMARY

For this purpose, the subject matter herein discloses a method for improving the wear resistance properties of a component comprising:
a) depositing a layer comprising molybdenum by thermal spraying on all or part of the surface of the component; and
b) bringing the surface of the component having a layer comprising molybdenum in contact with an aqueous solution at a temperature above room temperature.

The method according to the disclosure herein has at least one of the following optional features, taken individually or in combination.

The surface of the component to be treated is made of a material selected from titanium alloys, nickel alloys and austenitic stainless steels.

The component to be treated is a component selected from the components of a ball joint system, a cylinder rod, a ring, a gear, a camshaft, a valve, an injection pump, a bearing shell, a bearing and a shaft.

In step (a) of the method according to the disclosure herein, thermal spraying employed is plasma spraying.

In step (a) of the method according to the disclosure herein, the layer deposited by thermal spraying comprises predominantly molybdenum.

In step (b) of the method according to the disclosure herein, the aqueous solution only comprises water.

In step (b) of the method according to the disclosure herein, the aqueous solution comprises at least one other element in addition to the solvent.

In step (b) of the method according to the disclosure herein, bringing into contact is carried out in static mode or in dynamic mode.

In step (b) of the method according to the disclosure herein, bringing into contact has a duration between 1 h (hour as used herein) and 54 h (hours as used herein) and notably between 5 h and 48 h.

The method according to the disclosure herein has, prior to step (a), a step of sandblasting the surface or a machining step.

The disclosure herein also relates to a component, on all or part of the surface of which a layer is deposited comprising molybdenum, which is then subjected to hydration at a temperature above room temperature in accordance with the method as defined above.

### BRIEF DESCRIPTION OF THE DRAWINGS

FIG. 1 shows the variation of the friction coefficient with the number of cycles applied for a component treated according to the method of the disclosure herein, i.e. a component whose surface is coated with a layer comprising molybdenum and then undergoes hydration at a temperature greater than or equal to 40° C.

FIG. 2 shows, for comparison, the variation of the friction coefficient with the number of cycles applied for a component whose surface is coated with a layer comprising molybdenum but does not undergo hydration at a temperature greater than or equal to 40° C.

FIG. 3 shows, for comparison, the variation of the friction coefficient with the number of cycles applied for a component whose surface is coated with a layer comprising molybdenum and then a layer of organic resin.

### DETAILED DESCRIPTION

The subject matter herein discloses a method of treatment in two steps, only the first of which requires equipment suitable for thermal spraying, notably plasma spraying. The second step is very easy to carry out since it is hydration at a moderate temperature, i.e. above room temperature.

The motivated combination of a treatment with deposition of a layer comprising molybdenum and hydration makes it possible to improve the wear resistance properties of a mechanical component significantly. The second treatment, which corresponds to hydration, maintains the improvement in terms of wear resistance supplied by the layer comprising molybdenum, since this hydration maintains the porosity of the layer comprising molybdenum. Other known treatments such as the deposition of an organic resin would have an opposite effect in that they cancel the improvements supplied by the layer comprising molybdenum.

Moreover, the motivated combination of a treatment with deposition of a layer comprising molybdenum and hydration does not alter, or even improves the corrosion resistance of the component treated.

Finally, the method of treatment in two steps is usable on all mechanical components without any constraint regarding the materials of which they consist and regarding the temperature at which these mechanical components are used.

Thus, the disclosure herein relates to a method for improving the wear resistance properties of a component comprising the following steps of:
a) depositing a layer comprising molybdenum by thermal spraying on all or part of the surface of the component; and
b) bringing the surface of the component having a layer comprising molybdenum into contact with an aqueous solution at a temperature above room temperature.

“Improvement of the wear resistance properties” means that the component according to the method of the disclosure herein, i.e. the component of which at least one zone of the surface has a layer comprising molybdenum and has undergone hydration at a temperature above room temperature, has improved wear resistance properties relative to the same component but untreated.

“Room temperature” means a temperature of 22° C.±5° C. Consequently, “above room temperature” means a temperature above 27° C.

“Untreated component” means a component that has neither been coated with a layer comprising molybdenum, nor has undergone hydration at a temperature above room temperature. This improvement may be demonstrated or quantified by techniques that are familiar to a person skilled in the art, such as measuring the value of the friction coefficient.

Typically, the value of the friction coefficient is measured in the presence of a lubricant interposed between the two components that are sliding, rolling or swivelling relative to one another. Any lubricant commonly used in the aeronautical field may be employed for this purpose. As particular examples of such lubricants, we may mention lithium-based lubricants and notably lubricants comprising (i) a synthetic oil based on hydrocarbons and esters and thickened with lithium complexes, (ii) oxidation and corrosion inhibitors and (iii) load carrying additives. An example of such lubricants is the product AeroShell Grease 33® produced by Shell.

The value of the friction coefficient is measured with elementary test specimens of the type with a pin sliding on a track in the presence of a lubricant, notably as defined above.

In the same operating conditions, the friction coefficient of the component treated according to the method of the disclosure herein is reduced relative to the friction coefficient obtained for the untreated component.

Moreover, note that, in the same operating conditions, the friction coefficient of the component treated according to the method of the disclosure herein is reduced relative to the friction coefficient obtained for the component that has only undergone step (a) of the method according to the disclosure herein, i.e. a component of which at least one surface zone has a layer comprising molybdenum but that has not undergone hydration. Thus, in the operating conditions as defined in the experimental section below, the friction coefficient of the component treated according to the method of the disclosure herein is reduced by at least 5% and notably by at least 10% relative to the friction coefficient obtained for the component that has only undergone step (a) of the method according to the disclosure herein, i.e. a component of which at least one surface zone has a layer comprising molybdenum but that has not undergone hydration.

The disclosure herein applies to any component whose surface, when in contact with a second component, is likely to be subjected to at least one of the two types of wear by friction described above, i.e. either to fretting wear, or to wear by sliding.

In the sense of the disclosure herein, “surface” is to be understood as the external part of an object or solid body, which limits it in all directions. It is possible, for one and the same object (or solid body), to define conceptually different surfaces. The disclosure herein applies to any type of surface regardless of its geometry. The latter may be simple, such as a perfectly flat surface, or more complex, such as a concave or convex surface, regardless of the material constituting the surface and the rest of the component on which it depends.

In the context of the disclosure herein, the surface of the component to be treated, i.e. the component whose wear resistance properties are to be improved, may be an inorganic surface, an organic surface such as a resin, or a composite surface such as a composite with an organic matrix, a composite with a ceramic matrix or a composite with a metallic matrix.

In particular, when the surface of the component to be treated is an inorganic surface, the latter may be a surface of a conductive material, of a semiconductor material and/or of an insulating material.

Among the conductive materials employed in the context of the disclosure herein, we may mention metals, noble metals, oxidized metals, transition metals, metal alloys and, as particular, nonlimiting examples, nickel, zinc, gold, platinum, titanium, steel, mixtures thereof and alloys thereof. More particularly, the surface of the component to be treated is made of a material selected from titanium alloys, for example the alloy called TA6V, which is a titanium alloy comprising titanium, 6 wt % of aluminum and 4 wt % of vanadium, nickel alloys, for example, Inconel 718®, and austenitic stainless steels.

In the context of the disclosure herein, the component to be treated may be a component selected from the components of a ball joint system such as a ball or a joint ball, a cylinder rod, a ring such as a sealing ring, a gear, a camshaft, a valve, an injection pump, a bearing shell, a bearing and a shaft.

In the context of the disclosure herein, the component to be treated may be of any size and shape. The particular feature of the method according to the disclosure herein is that it is usable both on small and on large components.

The first step of the method according to the disclosure herein (step (a)) consists of or comprises depositing a layer comprising molybdenum on the component to be treated, by thermal spraying.

Any thermal spraying technique may be used in the context of the disclosure herein. It is notably selected from the group consisting of torch spraying, wire arc spraying, supersonic flame spraying and plasma spraying.

Thermal spraying employed in step (a) of the method according to the disclosure herein is plasma spraying.

Plasma spraying, also called “plasma spray”, is a method of thermal coating that consists of or comprises introducing a particulate material into a plasma jet, in which the particles are melted and accelerated before they crash on the surface to be coated. Thus, plasma spraying makes it possible to obtain a coating of high quality by combining a highly energetic high-temperature heat source with a relatively inert spray medium (plasma gas) and particles at high speed.

Step (a) of the method according to the disclosure herein may be carried out under ambient air (it is then called APS method, for “Air Plasma Spraying”) or in a chamber containing a neutral gas. In the latter case, the method employed depends on the particular conditions present in the chamber and this method may be designated as the LPPS method for “Low Pressure Plasma Spraying”, IPS method for “Inert Plasma Spraying”, or ATC PS method for “Atmosphere and Temperature Controlled Plasma Spraying”.

Various types of plasma gases are known that may be used in the plasma spraying of step (a) according to the disclosure herein, and these are notably selected from oxygen, propane, helium, argon, hydrogen, xenon, neon, krypton and mixtures thereof. “Mixtures” means both binary mixtures such as a mixture of argon and hydrogen, a mixture of oxygen and propane or a mixture of argon and helium, and ternary mixtures such as a mixture of helium, argon and hydrogen.

Typically, the component is fixed and centered on the surface to be coated on a turntable rotated by a motor. As a variant, the component to be coated may be moved in translation by a motor. Coolers positioned at the periphery of the component ensure that its temperature remains constant and close to room temperature to avoid distortion of the component or degradation of its mechanical characteristics.

In a first embodiment of step (a) of the method according to the disclosure herein, the layer comprises predominantly molybdenum. “Predominantly” means that the proportion by weight of molybdenum relative to the total weight of the layer is greater than or equal to 70%. The proportion by weight of molybdenum relative to the total weight of the layer may be greater than or equal to 80%, typically greater than or equal to 90%, notably greater than or equal to 95%, in particular greater than or equal to 96%, more particularly greater than or equal to 97%, even more particularly greater than or equal to 98%, or even greater than or equal to 99%. The other elements optionally present are elements of addition and/or impurities, the total amount of which expressed by weight relative to the weight of the layer comprising molybdenum is less than or equal to 30%. The total amount by weight of the other elements is less than or equal to 20%, typically less than or equal to 10%, notably less than or equal to 5%, in particular less than or equal to 4%, more particularly less than or equal to 3%, even more particularly less than or equal to 2%, or even less than or equal to 1% relative to the total weight of the layer.

In a second embodiment of step (a) of the method according to the disclosure herein, the layer is a layer of a molybdenum alloy and notably of an alloy of molybdenum and copper.

Following step (a) of the method according to the disclosure herein, all or part of the surface of the component to be treated is coated with a layer comprising molybdenum, the layer being porous, with pore size of the micrometric order.

Typically, the thickness of this layer is between 100 μm and 2 mm, notably between 110 μm and 1 mm and, in particular, between 120 μm and 700 μm. To achieve the thickness for the layer comprising molybdenum, it may be necessary for this layer to undergo a treatment for reducing its thickness, such as milling, grinding or machining, that is, following step (a) and prior to step (b) of the method according to the disclosure herein.

The second step of the method according to the disclosure herein (step (b)) consists of or comprises subjecting the surface of the component coated with a layer comprising molybdenum to hydration. This hydration is carried out in the presence of an aqueous solution and at a temperature above room temperature.

The solution employed in step (b) of the method according to the disclosure herein comprises water as solvent, thus justifying the designation of aqueous solution. “Water” means tap water, deionized water, distilled water or ultrapure water (18.2 MΩ). The solution employed in step (b) of the method according to the disclosure herein may be a neutral, acid or basic aqueous solution. A person skilled in the art will be able to determine the most suitable pH and consequently modify the pH of the aqueous solution, if necessary.

Typically, the aqueous solution employed in step (b) only comprises water. As a variant, it may comprise at least one other element in addition to the solvent. Any element able to improve certain properties of the coated component or able to accelerate or facilitate the method according to the disclosure herein may be present in the aqueous solution employed in step (b). As examples of another element, we may mention a corrosion inhibitor additive and an oxidation inhibitor additive. As more particular examples of another element, we may mention an element selected from the group consisting of a fluorinated compound, a stannate-based compound, a molybdate-based compound, a silicate-based compound, a cerium(III)-based compound, a phosphate-based compound, a (di)chromate-based compound, a cobalt-based compound, a carboxylate-based compound, a sulphite-based compound and mixtures thereof.

In a first embodiment, step (b) consists of or comprises preparing an aqueous solution as defined above at a temperature T above room temperature and then bringing this solution into contact with the surface of the component that has a layer comprising molybdenum and maintaining the whole at the temperature T.

In a second embodiment, step (b) consists of or comprises preparing an aqueous solution as defined above at room temperature and then bringing this solution into contact with the surface of the component that has a layer comprising molybdenum and bringing the whole to a temperature T greater than or equal to room temperature.

This temperature T, called “treatment temperature”, is assumed to have been reached when measurement of the temperature of the aqueous solution carried out using a suitable approach or means of metrology, for example a thermometer or thermocouple, gives a value close to the desired temperature for typically 15 min, to within the measurement uncertainty.

In the context of the disclosure herein, the treatment temperature is above 30° C., notably above 40° C., typically between 40° C. and 98° C., in particular between 60° C. and 97° C. and, more particularly, between 80° C. and 95° C.

In the method according to the disclosure herein, the surface of the component that has a layer comprising molybdenum may be brought into contact with the aqueous solution by any approach or means allowing uniform hydration of the surface of the component that has a layer comprising molybdenum. Thus, the contacting in step (b) may be performed in static mode or in dynamic mode.

In the “static mode”, also called “batch mode”, the surface of the component that has a layer comprising molybdenum and typically the component are immersed and held in the aqueous solution, the latter optionally being stirred. The stirring to which the aqueous solution is optionally subjected may be mechanical stirring, magnetic stirring or stirring by ultrasound. For this purpose, a mixer, a stirrer, a magnetic bar, an ultrasonic bath or a homogenizer may be used.

In “dynamic mode”, also called “column mode”, the aqueous solution flows over the surface of the component that has a layer comprising molybdenum.

The contacting between the surface of the component that has a layer comprising molybdenum and the aqueous solution is carried out for a time of less than 96 h, notably less than 72 h and, in particular, less than 60 h.

Advantageously, this contacting has a duration between 1 h and 54 h and notably between 5 h and 48 h.

In the context of the method according to the disclosure herein and more particularly during the contacting step, when the latter is carried out in static mode, it may be necessary to make up the volume of aqueous solution permanently with water, in order to compensate for the evaporation caused by the treatment temperature. Any device making it possible to maintain a substantially constant volume of aqueous solution notably by condensation of the vapors (reflux installation) may be used advantageously.

Moreover, in the context of the method according to the disclosure herein and more particularly during the contacting step, it is necessary to maintain the temperature of the aqueous solution at the treatment temperature as defined above. For this purpose, contacting is carried out in the presence of a heating element and a temperature regulator that is able to maintain the heating element at a set temperature, selected so that when the set temperature is obtained and maintained, the temperature of the aqueous solution is maintained at the treatment temperature.

At the end of the method according to the disclosure herein, i.e. once the time for contacting between the surface of the component that has a layer comprising molybdenum and the aqueous solution has elapsed, the surface may undergo rinsing. This rinsing step notably makes it possible to remove the other elements that may be present in the aqueous solution in addition to the solvent, as defined above. This rinsing is typically carried out with the same solvent as the solvent of the aqueous solution. Once the surface of the component that has a layer comprising molybdenum has been rinsed, it is left to dry in a clean environment, to prevent any solid or liquid contamination of the surface of the treated component.

If contacting was carried out in static mode, the surface of the component that has a layer comprising molybdenum and therefore the component are removed from the aqueous solution and then washed by immersing them in a washing solution or by causing the washing solution to flow over this surface. If contacting was carried out in static mode, the aqueous solution flowing over the surface of the component that has a layer comprising molybdenum is replaced with the washing solution.

The method according to the disclosure herein may have, optionally prior to carrying out step (a), a step for preparing the component and promoting adherence of the molybdenum-based layer on the surface of the component to be treated, notably by increasing the adhesion of the molybdenum-based layer by mechanical anchoring and/or by increasing the roughness of the surface to be coated. The step may consist of or comprise a step of sandblasting of the surface, i.e. a step of spraying with abrasives, or a machining step.

The disclosure herein also relates to a component, on all or part of the surface of which a layer comprising molybdenum is deposited, and which then undergoes hydration at a temperature above room temperature in accordance with the method as defined above.

All the foregoing explanations for the method apply mutatis mutandis to the component according to the disclosure herein.

Other features and advantages of the disclosure herein will become clearer on reading the example given below, for purposes of illustration, and nonlimiting.

### I. Treatment According to the Method of the Disclosure Herein

I.1. Step of Depositing a Layer Comprising Molybdenum

A component made of TA6V, in the form of a plate, is coated by plasma spraying with a layer comprising molybdenum with a thickness of 150±20 μm once it has been finished by milling, grinding or machining.

I.2. Hydration Step

Once coated with the layer comprising molybdenum, the component made of TA6V in the form of a plate is placed in tap water for 24 h at a temperature between 80 and 95° C.

### II. Measurement of the Friction Coefficient

The wear behavior is investigated by sliding between a copper alloy pin and a track made of TA6V in the presence of a lubricant of the AeroShell Grease 33® type produced by Shell, with a frequency of 8 Hz and a contact pressure of 530 MPa as the test conditions. The value of the friction coefficient is measured on a tribometer.

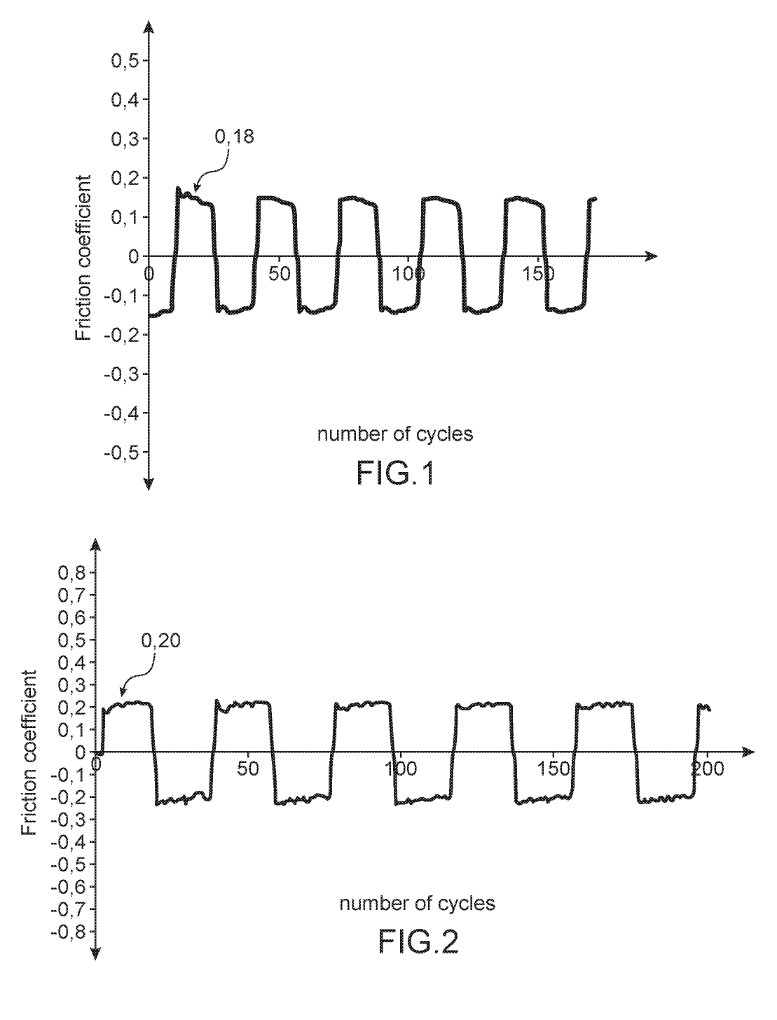

When this surface has undergone the method of treatment as defined in point I above, the friction coefficient is 0.18 (FIG. 1).

Note that a surface of TA6V that has only undergone the first step of the method according to the disclosure herein as defined in point I.1 above has a friction coefficient of 0.20 (FIG. 2).

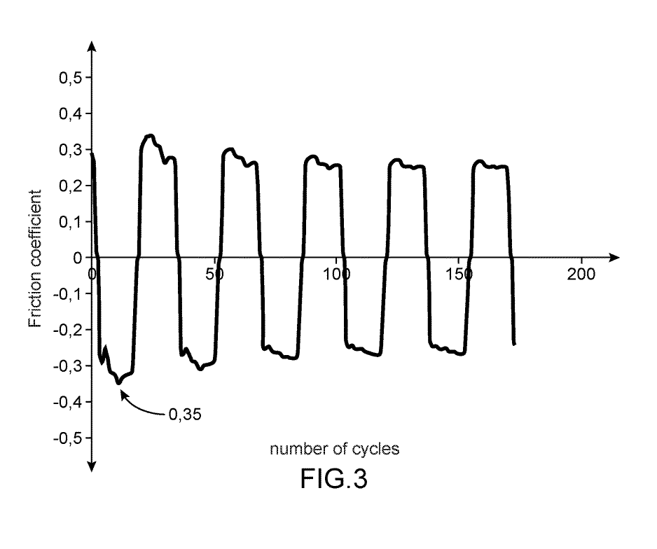

For comparison, a surface of TA6V covered with a layer comprising molybdenum according to the protocol as defined in point I.1, the layer subsequently being covered with a layer of organic resin, has a friction coefficient of 0.35 (FIG. 3).

Moreover, the friction coefficient obtained for the surface of TA6V that has undergone the method of treatment as defined in point I above is stable up to a value of 300,000 cycles, whereas, in the same conditions of distance covered, the friction coefficient of a surface of TA6V coated with a layer comprising molybdenum and a layer of an organic resin is unstable but always at high values, i.e. greater than or equal to 0.35, starting from 60,000 cycles.

As already explained, hydration does not alter the porous structure of the layer comprising molybdenum, in contrast to the organic resin, which blocks the pores of this layer. The pores present in the layer of molybdenum play the role of a reservoir of lubricant in the conditions tested and therefore in the conditions of use of the metallic components treated according to the method of the disclosure herein.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for improving wear resistance properties of a component comprising steps of:
a) depositing a layer comprising molybdenum by thermal spraying on all or part of a surface of the component; and
b) bringing the surface of the component having a layer comprising molybdenum into contact with an aqueous solution at a temperature above room temperature.

2. The method of claim 1, wherein the surface of the component is made of a material selected from the group consisting of titanium alloys, nickel alloys and austenitic stainless steels.

3. The method of claim 1, wherein the component is selected from the group consisting of components of a ball joint system, a cylinder rod, a ring, a gear, a camshaft, a valve, an injection pump, a bearing shell, a bearing and a shaft.

4. The method of claim 1, wherein, during step (a), thermal spraying employed is plasma spraying.

5. The method of claim 1, wherein, during step (a), the layer deposited by thermal spraying comprises predominantly molybdenum.

6. The method of claim 1, wherein, during step (b), the aqueous solution only comprises water.

7. The method of claim 1, wherein, during step (b), the aqueous solution comprises at least one other element in addition to a solvent.

8. The method of claim 1, wherein, during step (b), contacting is carried out in static mode or in dynamic mode.

9. The method of claim 1, wherein, during step (b), the contacting has a duration between 1 hour and 54 hours.

10. The method of claim 9, wherein, during step (b), the contacting has a duration between 5 hours and 48 hours.

11. The method of claim 1, comprising, prior to step (a), a step of sandblasting the surface or a machining step.

12. A component, on all or part of a surface of which a layer is deposited comprising molybdenum in a proportion by weight greater than or equal to 70% relative to total weight of the layer, and which has undergone hydration at a temperature above room temperature by the surface of the component contacting an aqueous solution.
